(19) United States
(12) Patent Application Publication
(10) Pub. No.: US 2022/0036328 A1
(43) Pub. Date: Feb. 3, 2022

(54) Activating Monetization for Uncompensated Online Content Creators

(71) Applicant: Joshua Garth Kaye, Honolulu, HI (US)

(72) Inventor: Joshua Garth Kaye, Honolulu, HI (US)

(21) Appl. No.: 17/387,400

(22) Filed: Jul. 28, 2021

Related U.S. Application Data
(60) Provisional application No. 63/058,472, filed on Jul. 29, 2020.

(51) Int. Cl. G06Q 20/12; G06F 21/10

(52) U.S. Cl. CPC G06Q 20/1235; G06F 21/10

(57) ABSTRACT

A method of incorporating identifiable copyrighted work into an uncompensated content creator's content, so that the platform will detect the presence of the copyrighted work and pay revenues to the copyright owner, and the copyright owner then shares the revenues with the content creator. An agreement is made between the uncompensated content creator and the copyright owner that revenue received by the copyright owner from the platform as a result of the uncompensated content creator incorporating the copyright owner's copyrighted work into the uncompensated content creator's content will be shared with the content creator by the copyright owner.

This application claims the priority of U.S. provisional patent application No. 63/058,472 filed Jul. 29, 2020.

### TECHNICAL FIELD

The present invention relates to a method for building a special kind of digital content that, when shared on a platform (for instance uploaded to the video sharing platform YouTube or uploaded to the social media platform Instagram) by a content creator, has the unique ability to generate income for that content creator, even when that content creator has been otherwise excluded from the platform's monetization program(s).

### BACKGROUND ART

The computer technology of online social media platforms (such as Instagram) and video sharing platforms (such as YouTube) has greatly advanced the ability for people to share content with friends, family, and audiences around the world. Unfortunately, the technology has also created a new set of problems. One such problem is that disinformation spreads quickly throughout the platforms and is difficult for the platforms to control. A second problem is that people who spend time viewing content on the platforms have their viewing behavior analyzed and personal information collected in ways that not only subject them to targeted marketing, but also make them vulnerable to nefarious actors. A third problem is that platforms employ methods of psychological manipulation to encourage people to spend more time viewing content on the platforms. These tactics lead to social media addiction in both children and adults.

Another widespread problem that has arisen from this computer technology is that the platforms use content posted by people to generate profits solely for the platforms, without compensating these content creators for their content. The content creators have no choice but to allow this exploitation, because it is the only way the content creators are able to access the new content sharing technology provided by the platforms.

The present invention provides a solution to this problem.

For the purposes of this invention, the term “platform” will refer to any online service which enables people to share digital content with others. For instance, the video sharing platform YouTube allows people to upload and share videos with others.

The social media service Instagram allows people to share pictures and videos with others. The video live streaming service Twitch allows people to share “live” streamed videos (Twitch videos are broadcast in real time, similar to television live sports events or television live news broadcasts). Soundcloud is a music sharing platform where people upload original recorded music to share. The above examples are all platforms which run on “centralized networks”. This means, for instance, that Youtube stores all of the videos which are uploaded and then people can view those videos by accessing the YouTube site online. A decentralized network is one where the content is shared online directly from one person to another person (or persons), sometimes called “peer to peer”.

A popular platform that utilized a decentralized network called Napster was primarily a music sharing service which enabled people to share music recordings with one another (Napster was shut down after being sued by record companies who claimed losses of record sales from illegal sharing of music recordings). Although most of the popular platforms currently run on centralized networks, there are social media platforms (such as one called Minds) and video sharing platforms (such as a YouTube alternative called LBRY) which run on decentralized networks. On decentralized networks, the content which is shared is not uploaded to the platform and stored by the platform before being shared. Instead, the platform may facilitate the sharing of content between people by offering services such as: enabling people to find or “search” for content they want, screening content, and/or making the transfer of content more secure. For this invention, “platforms” can exist on centralized networks, decentralized networks, or “hybrid” networks which have characteristics of both centralized and decentralized networks.

Technologies such as 3D (three dimensional) video and 360 degree video (also known as omnidirectional video or panoramic video) offer a glimpse of what platforms of the future may be like. 3D video adds a dimension of perceived depth to a video so that people who are watching the video will feel as if objects in the video are close to them, farther away from them, moving toward them, or moving away from them. 360 degree video creates a “panoramic” effect which allows people watching the video to feel as if the video is surrounding them in all directions, instead of the video being positioned only in front of them. By using headsets (or helmets) with built in screens and speakers, and haptic technology (technology that engages a person's sense of touch by applying force or vibrations), people may “experience” videos of the future in a way that makes them feel as if they are truly in an alternative reality. Also, computer technology may add an interactive element to video so that the content people are eventually sharing on platforms is not mere videos, but complex interactive computer programs which contain audio, video, and haptic data. Methods of creating these alternative reality programs may be simplified so that this sort of content is no more difficult to create than creating videos is today. The platforms of tomorrow may enable people to share these complex computer programs (which are “experienced” by people instead of just “viewed” by people) with each other. This invention is designed to work on any platform, and with any content that people contribute on a platform to be shared with others.

Virtual reality technology refers to computer simulated environments. In the case where people share content within a computer simulated environment, the computer simulated environment may function as the “platform” with regard to this invention. Many of the things that exist in the real world will also exist in these virtual environments. For example, people may attend a “virtual” sporting event or attend “virtual” music concerts. There will be “virtual” business meetings and “virtual” movie theaters. There may even be “virtual” platforms for sharing videos such as a “virtual” YouTube within the computer simulated environment. In the case of a platform which exists within a computer simulated environment this invention will work as well.

Augmented reality technology and mixed reality technology refer to overlaying digital content onto the real world. In 2016, a popular game available on mobile devices (smartphones and tablets) called “Pokémon Go” was an example of augmented reality. The game worked in part by accessing the camera on people's mobile devices (such as smartphones). While people walked around viewing their real world surroundings through their mobile devices, the game added an overlay of digitally created creatures which appeared to be existing in the real world environment, as viewed on the mobile device display (the display is the screen which is viewed on a mobile device).

In a “mixed reality environment” (as opposed to an “augmented reality environment”), the device being used must receive information from the real world environment so that the digital overlays can appear to actually interact with the real world environment. For instance, if Pokémon Go had been an example of mixed reality, the digital creatures may have appeared to walk up real world stairs or climb onto real world furniture (as viewed on the mobile device display). Since Pokemon Go was augmented reality (not mixed reality), the digital creatures were visible in the real world environment (as viewed on the mobile device display) but did not appear to be aware of the real world environment.

In the future, it may be possible for many people to contribute digital content which is overlaid on real world surroundings as viewed through a mobile device (or perhaps a related device like Google Glass, which is a lightweight computer resembling normal eyeglasses with transparent display screens positioned in front of the eyes). These digital overlays might be shared as content on a platform and made visible to other people when those other people logged in or visited the online platform.

Now that the term “platform” has been explained, the term “sharing content on a platform” should be clarified with respect to the description of this invention. “Content” refers to anything which is shared on the platform. The videos which are shared on YouTube are content. On Instagram, content refers to the photos, pictures, and text. On the review site Yelp, which publishes public reviews of businesses, the reviews are content along with any pictures which accompany the reviews. On Soundcloud, the content is music. On the audio streaming platform Spotify, music, podcasts, and playlists are the content. Any form of content which is shared on a platform can be used in this invention. On current popular platforms such as the ones just mentioned, “sharing content on a platform” refers to the act of uploading content to a platform so it can be viewed (or heard) by other people. As discussed above, YouTube and Instagram are centralized platforms. In the case of decentralized platforms, it may not be necessary to “upload” content in order to share it. In the case of Napster, content was shared without being uploaded to a Napster site which stored the content. So “shared on a platform” can refer to any method which enables content to be shared with others on a platform. This includes, but is not limited to, “streaming” content (allowing others to view content without first completely downloading the content), as well as various methods of file transfer (various file transfer methods are also discussed in Step 2 of this method).

A term which will be discussed in more detail in Step 1 is “copyrighted works”. One of the major issues platforms have been facing regarding copyrighted works is that people who share content on platforms often share content that does not belong to them. For instance, if newlyweds post a video on YouTube of the first dance at their wedding, the music that is playing during their first dance is a copyrighted work which most likely does not belong to them. In order to deal with issues like this, YouTube has established a system called “Content ID”, which can detect and identify copyrighted music within posted videos, and then notify the owner of the copyrighted music (“Content ID” will be discussed further in Step 1). The owner of the copyrighted music is given two choices: if the owner of the copyrighted music wishes to have the posted video blocked, Youtube will remove the video from the platform. Or, if the owner of the copyrighted music prefers, YouTube will run ads before and/or during the video and give a portion of that ad revenue to the owner of the copyrighted music. Most copyright owners prefer to receive a portion of the ad revenue rather than block the video. In November 2018, YouTube reported that it had paid over three billion dollars to copyright owners who had monetized use of their content through Content ID (MANARA, C. Nov. 7, 2018 [retrieved on 2020 Jul. 29]. Retrieved from the Internet:<URL: https://www.blog.google/outreach-initiatives/public-policy/protecting-what-we-love-about-internet-our-efforts-stop-online-piracy/)

In the description of this invention, the term “copyrighted works” often refers to the examples of music, video, or images. But this invention can function using all types of “copyrighted works” (any works which are considered legally copyrightable).

Finally, the term “content creator”, which will be further explained below in this “Background Art” section, refers to those people who share content online with other people through the use of a platform.

YouTube is an online video sharing platform where people upload and share videos. In 2018, 500 hours of video were uploaded to YouTube every minute, (TIMBERG, C., “Not suitable for impressionable minds”, Los Angeles Times, Monday, Mar. 25, 2019, p. A10, incorporated herein by reference) and in the year 2020, one billion hours are being watched daily on the YouTube platform (ANDERSON, M., “YouTubers aren't always happy with video policies”, The Baltimore Sun, Sunday, Apr. 8, 2016, p.23, incorporated herein by reference). The first video was uploaded to YouTube in 2005 and in August of 2007, YouTube began making money from advertisers by placing ads before and during videos which were uploaded to the platform. Several months later, in December of 2007, YouTube created a “YouTube Partner Program” and began sharing this ad revenue with those people whose uploaded videos had ads running on them. (JOHNSON, S., “Pay per view”, Chicago Tribune. Tuesday, Aug. 10, 2010 Section 3 p. 1, incorporated herein by reference). As a result of establishing this monetization program, a viable source of income had begun for these “YouTube Partners”, and they began to be known as “YouTubers” or “content creators”.

Some of the most popular types of videos that are uploaded to YouTube are product review videos, educational videos, comedy videos, and “how to” videos. An example of a “how to” video might be one in which a plumber shows how to unblock a clogged bathtub drain. A Pew Research Center poll taken in 2018 found that over half of U.S. adults that use YouTube say “the site is very important when it comes to figuring out how to do things they haven't done before.” (Survey by Pew Research Center of U.S. adults conducted May 29-Jun. 11, 2018 “Many Turn to YouTube for Children's Content, News, How-To Lessons.” [retrieved on 2020 Jul. 15]. Retrieved from the Internet:<URL: https://www.pewresearch.org/internet/2018/11/07/many-turn-to-youtube-for-childrens-content-news-how-to-lessons/, incorporated herein by reference). Some videos become extremely popular and are known as “viral videos”. Viral videos are often popular because they are very entertaining. One of the most popular viral videos on YouTube was uploaded in 2007 and is called “Charlie Bit My Finger”. It currently has been viewed over 875 million times. The video is a candid recording from England of a three-year-old boy who allows his one-year-old brother to bite his finger. In 2011, four years after the video had been uploaded to YouTube, it was reported that the family had made over £100,000, which was enough for them to purchase a new house.

From 2012 to 2018, all YouTube content creators were allowed to monetize their video content through ad revenue (Since 2013, YouTube pays 55% of ad revenue to the content creator whose video posts have ads running on them and keeps 45%). (SPANGLER, T., Nov. 1, 2013. retrieved on 2020 Jun. 29]. Retrieved from the Internet:<URL: https://variety.com/2013/digital/news/youtube-standardizes-ad-revenue-split-for-all-partners-but-offers-upside-potential-1200786223/) But in 2018, YouTube changed its policy to allow only a small percentage of content creators to monetize their video posts. In order to qualify to be a “Youtube Partner” and have your video content monetized by ad revenue, you now needed to have 1000 subscribers to your channel (every content creator on YouTube has his or her own “channel” on which he or she posts his or her videos). YouTube also required that a channel have a minimum amount of 4000 watched hours in the previous year. If these qualifications were met, a content creator could apply to the Youtube Partner Program. (PIERSON, D., “YouTube's balancing act: stars vs. advertisers”, Los Angeles Times, Tuesday, Jan. 30, 2018, p. C4, incorporated herein by reference).

This YouTube Partner policy change made many content creators unhappy. Many who had been receiving revenue by posting videos were now unable to receive that revenue. And content creators who were starting out their businesses as “YouTubers”, would be unable to collect revenue, even if they posted videos which were highly popular and useful to viewers, if they did not yet have 1000 subscribers to their channel. These new restrictions meant that a plumber who had posted a helpful video on how to unclog a drain would not be able to generate revenue on YouTube if his or her YouTube channel didn't have 1000 subscribers. And someone who uploaded a video which went “viral” could not receive the substantial revenue that viral videos can generate if that content creator did not qualify for YouTube's monetization program. A newspaper article which appeared in the Apr. 5, 2018 copy of USA Today entitled “Many Youtube creators frustrated by changes in policies, practices” (p. 6b) is one of many published articles which portray the struggle content creators are now facing as a result of YouTube blocking the flow of income that content creators had previously been receiving through ad revenue. (MOLINA, B., “Many YouTube creators frustrated by changes in policies, practices”, USA Today. Apr. 5, 2018 p. 6b, incorporated herein by reference).

In February of 2020, it was reported that YouTube had generated over 34 billion dollars in ad revenue over the previous three years. Earnings reports revealed that almost 5 billion dollars in ad revenue had been generated in the last quarter of 2019 alone.

Currently, YouTube shares over half of that revenue with content creators who qualify for the YouTube Partner program (As stated earlier, YouTube keeps 45% of ad revenue and gives 55% to the content creators whose videos have ads running on them). Content creators who do not qualify for monetization remain frustrated that they are missing out on this revenue. (ALEXANDER, J. Feb. 4, 2020. [retrieved on 2020 Jul. 29]. Retrieved from the Internet:<URL: https://www.theverge.com/2020/2/4/21121370/youtube-advertising-revenue-creators-demonetization-earnings-google)

### DISCLOSURE OF THE INVENTION

In a first preferred embodiment, the present invention is a process for copyright owners to use identifiable copyrighted works that includes at least the following steps:

making available the identifiable copyrighted works, so that they can be incorporated into online content by online content creators (who have been excluded from monetization of their content by platforms for not meeting the platforms' monetization requirements), and then receiving compensation from the platforms for use of the copyrighted works when the content has been shared on the platform, and then paying the content creators a portion of the compensation.

In another preferred embodiment, the invention is a process for content creators (who have been excluded from monetization of their content by platforms for not meeting the platforms' monetization requirements) to use identifiable copyrighted works, that includes at least the following steps:

agreeing with owners of the identifiable copyrighted works to share compensation from use of the identifiable copyrighted works on platforms;

selecting identifiable copyrighted works offered by the owners of the identifiable copyrighted works;

incorporating the identifiable copyrighted works into the content;

sharing the content on the platforms, so that compensation to the owner of the identifiable copyrighted work is generated; and

receiving a portion of said compensation.

In still another preferred embodiment, the invention is a process for copyright owners to encourage broader usage of identifiable copyrighted works on platforms, and to increase revenue from the identifiable copyrighted works, that includes at least the following steps:

making available the identifiable copyrighted works, to be incorporated into online content by online content creators (who have been excluded from monetization of their content by the platforms for not meeting the platforms' monetization requirements);

receiving compensation from the platforms for use of the copyrighted works when the content with the incorporated identifiable copyrighted works has been shared on the platform; and

paying the content creators a portion of the compensation.

In still another embodiment, the invention is a process for platforms that own identifiable copyrighted works to encourage broader usage of the identifiable copyrighted works on the platforms, and to increase revenue from the identifiable copyrighted works, the includes at least the following steps:

making available the identifiable copyrighted works, to be incorporated into online content by online content creators (who have been excluded from monetization by the platforms for not meeting the platforms' monetization requirements);

paying compensation to the online content creators for use of the copyrighted works when the content with incorporated identifiable copyrighted works has been shared on the platform.

In still another embodiment, the invention is a process for copyright owners of identifiable copyrighted works to encourage broader usage of the copyrighted works on platforms, and to increase revenue from the identifiable copyrighted works, that includes at least the following steps:

making available to online content creators (who have been excluded from monetization by the platforms for not meeting the platforms' monetization requirements), identifiable copyrighted works to be incorporated into content to be shared on the platforms, so that when the content creators share (on the platforms) content incorporating the copyrighted works, the copyright owners receive compensation for use of the copyrighted works; and

paying the content creators a portion of the compensation.

In still another preferred embodiment, the invention is a process for a platform to compensate online content creators (who have been excluded from monetization by the platform for not meeting the platform's monetization requirements) when the content creators share (on the platform) content incorporating identifiable copyrighted works owned by a copyright owner, including at least the following steps:

making available to the content creators the identifiable copyrighted works for selection of at least one of the copyrighted works to be incorporated into the content; and

paying the copyright owner a share of compensation for use of the identifiable copyrighted work when the content has been shared on the platform; and

paying the content creators a share of said compensation.

In still another preferred embodiment, the invention is a process for a copyright owner to encourage broader usage of identifiable copyrighted works on platforms, and to increase revenue from the identifiable copyrighted works, that includes at least the following steps:

making available the identifiable copyrighted works, to be incorporated into online content by online content creators (who have been excluded from monetization of their content by said platforms for not meeting the platforms' monetization requirements);

receiving compensation from the platforms for use of the copyrighted works when the content with incorporated identifiable copyrighted works has been shared on the platform; and

paying the content creators a portion of said compensation.

In this embodiment, the process could be practiced wherein the content creators have been excluded for not meeting the platforms' channel subscriber or viewing hours monetization requirements.

In still another preferred embodiment, the invention is the process of using identifiable copyrighted works incorporated into content by content creators (who have been excluded from monetization for failing to meet platforms' monetization requirements), comprising:

triggering payment of compensation to owners of the identifiable copyrighted works when the content is shared on the platforms, in which the copyright owners pay portions of the compensation to the content creators.

In still another preferred embodiment, the invention is a process for a copyright owner to use identifiable copyrighted works, including at least the following steps:

making available the identifiable copyrighted works to content creators to be incorporated into content to be shared on platforms; and

sharing with the content creators, revenue paid to the copyright owner by the platforms.

In this embodiment, the making available step could be performed by including a key word identifying the copyright owner in the copyrighted works' titles.

### BRIEF DESCRIPTION OF DRAWINGS

FIG. 1 is a flowchart showing the steps of the presently preferred best mode for carrying out the invention, which are shown by the following boxes and arrows labelled as follows in FIG. 1:

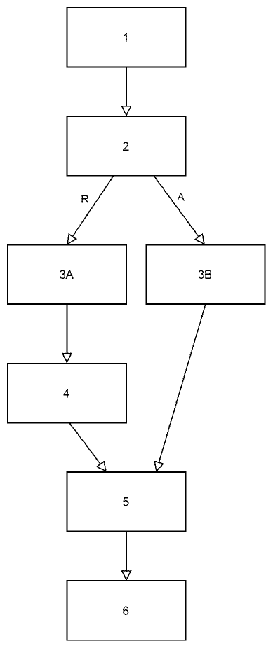

1. Copyrighted work becomes traceable by being processed by system such as “digital fingerprinting”.

2. Traceable copyrighted work is made available to uncompensated content creator with terms of use agreement. Does uncompensated content creator receive copyright owner's copyrighted work from copyright owner or by accessing through platform?

R. Receives from copyright owner

A. Accessed through platform

3A. Traceable copyrighted work which is received from copyright owner is incorporated into uncompensated content creator's content and shared on platform.

3B. Copyrighted work which is accessed through platform is incorporated into uncompensated content creator's content and shared on platform.

4. Traceable copyrighted work is detected and identified on platform by system such as “digital fingerprinting” and copyright owner is notified by platform. Copyright owner chooses to monetize content rather than block it.

5. The copyright owner receives revenue from the platform.

6. Copyright owner shares revenue with content creator as per agreement thereby making him or her a “compensated” content creator. The special kind of digital content has functioned as intended.

### BEST MODE FOR CARRYING OUT THE INVENTION

The presently preferred best mode for practicing the present invention is presently illustrated by way of example by the following method of building a special kind of digital content which allows presently uncompensated content creators to receive income for sharing content on a platform. An uncompensated content creator is a content creator who has been excluded from compensation by a platform for not meeting the platform's channel subscriber, viewing hours, or other monetization requirements.

Before the uncompensated content creator shares his or her content on a platform (such as sharing a video on YouTube), he or she obtains a copyrighted work made available by a copyright owner (for example, he or she visits a website where he or she can download the copyright owner's copyrighted work such as recorded music). The uncompensated content creator must agree to certain conditions of use before receiving (for example “receiving” by downloading) the copyrighted work. One of these conditions is that if the uncompensated content creator chooses to incorporate the copyrighted work into his or her content (for example by using copyrighted music as background music for his or her video), and as a result the copyright owner receives revenue from the platform's monetization from that content being shared on the platform (for example the copyright owner receives a portion of the advertising revenue the platform makes from running ads before or during the uncompensated content creator's posted video), then a portion of that revenue will be shared with the content creator by the copyright owner.

To avoid confusion throughout the description of this invention, the terms “content creator”, “compensated content creator”, and “uncompensated content creator” will refer to the person who is sharing content, such as videos, on a platform (such as YouTube or Instagram). The term “copyright owner” will refer to the person whose copyrighted works are being incorporated into the content which is being shared on a platform. While the deliberate use of these terms will help avoid confusion, it should be noted that the “copyright owner” often is someone who creates content and is therefore technically a content creator as well, and that the “content creator” is also someone who owns copyright rights and therefore is technically a copyright owner as well.

The flowchart which accompanies the description of this invention offers a visual reference of the six steps which are used to build the special kind of digital content that, when shared on a platform (for instance uploaded to the video sharing platform YouTube or uploaded to the social media platform Instagram) by a content creator, has the unique ability to generate income for that content creator, even when that content creator has been otherwise excluded from the platform's monetization program(s).

### Step 1:

Copyrighted work is processed through a system (such as a “digital fingerprinting system”) which can detect and identify the copyrighted work when it is shared on a platform (thereby making the copyrighted work “traceable” on a platform).

When someone records a piece of original music or creates a piece of visual art or other copyrightable work, he or she automatically has the exclusive legal right to copy and distribute that music or art or other copyrightable work. This right is called “copyright”. Copyright is automatic when a work is created and does not, in and of itself, add commercial value to music or art. It is simply a legal protection against those who might reproduce, distribute, or otherwise use the music or art or other copyrightable work without the permission of the copyright owner.

In this invention, the function of the copyrighted work (for example musical sound recordings, video, or images) extends beyond the traditional roles of copyrighted work (for example the roles of music and art as entertainment, beauty, and/or emotional power).

Copyrighted work as it is used in this invention will fulfill those traditional roles, but in this invention, it also functions as a preferable component of the special kind of content which is being built (this will be further discussed in Step 3a and 3b when the copyrighted work is incorporated into the uncompensated content creator's content).

The first step in this method is that the copyrighted work is processed by a system which will make it traceable. For example, the copyrighted work could be processed by a “digital fingerprinting system” (a technology that has emerged in recent years). Just as human beings have unique fingerprints which can be used for identification purposes, media such as sound recordings or video have unique characteristics which a computer program can use to identify when copies of the sound recordings or video have been uploaded onto a platform such as YouTube. For instance, if a piece of recorded music is processed by a digital fingerprinting system by a copyright owner, and then someone else uses that same music as background music for a video they upload to YouTube, the background music (even as it is mixed with other sounds on the video such as spoken dialogue, sound effects and other sounds that occur in the video) can be detected and identified by the digital fingerprinting system so the copyright owner can be notified that his or her music was used within an uploaded video on YouTube. A second example would be if a copyrighted video or image (photograph or artwork) was processed by a digital fingerprinting system and then someone combines a podcast (audio only) with that copyrighted video or image, and then uploads the podcast combined with that copyrighted video or image onto YouTube. Similarly, the digital fingerprinting system would detect and identify the copyrighted video or image which had been combined with the uploaded podcast, and the copyright owner could be notified that his or her video or image had been uploaded along with the podcast.

There are several digital fingerprinting systems currently being used on the various social networking and video sharing platforms. One video sharing platform called Dailymotion (a competitor of YouTube), uses digital fingerprinting systems made by two companies. One company is called Audible Magic and provides fingerprinting for audio. Audible Magic also provides digital fingerprinting for other video sharing and social media platforms. The other digital fingerprinting company Dailymotion uses is called INA, which provides fingerprinting for the video (without the audio).

For the digital fingerprinting systems to be engaged, a copyright owner submits his or her copyrighted audio or video to be processed by the Audible Magic or INA digital fingerprinting systems (copyright owners currently submit by uploading copyrighted audio and/or video to the Audible Magic or INA systems online, but it is possible that in the future a copyright owner could process his or her copyrighted work on his or her own computer using software such as Audio Magic or INA which is installed on his or her computer). Once the audio or video has been processed or “fingerprinted”, the digital fingerprinting systems will be able to detect when copies of the video or audio have been uploaded onto the Dailymotion platform, and Dailymotion notifies the copyright owner of the uploading.

Youtube has its own digital fingerprinting system called Content ID which works with both audio and video. The procedure is the same: the copyright owner submits the copyrighted audio or video to be processed by the Content ID system and then once the copyrighted material has been fingerprinted, the Content ID system will identify any content uploaded to YouTube that contains the fingerprinted audio or video and notify the copyright owner.

Thus, once the copyrighted work has been processed by the digital fingerprinting program and successfully fingerprinted, platforms can notify copyright owners if their copyrighted work has been uploaded to the platforms.

Another technology related to digital fingerprinting which can be used to detect and identify copyrighted work when it is shared on a platform is called “digital watermarking”. When copyrighted works are digitally watermarked, data is added to the copyrighted work to make it detectable and identifiable. This differs slightly from digital fingerprinting, which does not add data to copyrighted works, but instead analyzes copyrighted works for digital fingerprints that allow detecting and identification of any copyrighted work that has been incorporated into content that has been shared on a platform. Watermarking and digital fingerprinting are both methods which could be used to make copyrighted works (hat have been incorporated into digital content) traceable on a platform. Any technology (existing now or in the future) which enables copyrighted works to be traceable by making them detectable and identifiable when they are incorporated into content that is shared on a platform, can be used for this invention. For example, a copyright owner could include a key word identifying the copyright owner in that owner's copyrighted works' titles.

Besides considering that future technologies may provide alternative methods of making copyrighted works traceable on a platform, we must also consider that the type of copyrighted works which we will be making traceable may be computer programs. Within virtual reality environments, augmented reality environments, or mixed reality environments, the content which a content creator shares on a platform might be in the form of a computer program instead of digital audio or digital video media. Likewise, the copyrighted work which is being made traceable might also very well be a computer program. Computer programs are copyrightable under copyright law. Any type of copyrighted work (including computer programs) could potentially be used in this invention.

### Step 2:

The copyright owner makes the copyrighted work (which has been made traceable) available to an uncompensated content creator whose content is unable to be monetized by the platform, because he or she is excluded from participating in the platform's monetization program(s). In the example of YouTube, this uncompensated content creator may not qualify because his or her channel has not reached 1000 subscribers, or because his or her channel has not had 4000 hours of watch time in the previous twelve months. Currently, the copyright owner will most likely make the copyrighted work available to this uncompensated content creator through a “web application” or “mobile application”. A “web application” is an interactive website (a non-interactive website is sufficient for viewing web pages, but interactivity such as downloading copyrighted materials, agreeing to terms of use, and entering information to receive payments requires a web application). A “mobile application” is similar, but is designed to be accessible from a tablet, smartphone, or other mobile device. In this case, the web application or mobile application is where the uncompensated content creator can download the copyright owner's copyrighted work. For example, if the uncompensated content creator was looking for music as background music for a video post he or she planned to post to YouTube, he or she could visit this website where he or she could listen to different musical selections before choosing one to download so he or she could add it to a video as background music. Or perhaps the uncompensated content creator is looking for available images or video to accompany his or her podcast that he or she plans to upload to YouTube. Again, he or she can download these images or other copyrightable content made available by a copyright owner through a web application or mobile application.

As a condition for receiving a copyrighted work from the copyright owner (such as by initiating a download of the copyrighted work), a content creator must agree to terms of use as put forth by the copyright owner. One of these terms is that if the content creator uses the copyrighted work by combining it with the content creator's own content (for example using the copyrighted music as background music for the content creator's video) and the copyright owner (not the content creator) receives revenue (for example by Youtube monetizing the content creator's post through advertising and sending a portion of the ad revenue to the copyright owner), then that revenue will be shared between the copyright owner and the uncompensated content creator (thereby transforming the content creator from “uncompensated” to “compensated”). Also worth noting is the preferable unusual feature of this agreement that when the content creator uses the copyright owner's copyrighted materials, the content creator is paid by the copyright owner. Generally, a content creator who is looking to add background music to his or her video would pay the copyright owner of the background music for the use of the music. Here, with the use of the copyrighted work by the content creator generating revenue for the copyright owner, the situation is reversed. But here is why it works: The copyright owner receives revenue from the platform when the copyrighted work is incorporated into the content creator's content and shared on the platform. The copyright owner then shares that revenue with the content creator. However, if the copyrighted work is not incorporated into the content creator's content, then the copyright owner will not receive any revenue at all. It would be better for the copyright owner to allow the content creator to incorporate the copyrighted work into his or her content, and then for the copyright owner to share the resulting revenue with the content creator, than not to allow the incorporation of the copyrighted work and not receive any revenue. This agreement is a preferable component of this invention.

The web application (or mobile application) is also where the content creator will set up a way to receive future payments for the content creator's portion of the revenue (these transactions are commonly executed by use of an online payment system which supports online money transfers such as PayPal).

This part of the method (setting up account information for future payments) could be done at any time before payments are made. For example, the account may have been set up well before the content creator downloaded the copyrighted content (especially if the content creator has previously downloaded copyrighted materials and set up his or her account information on his or her initial visit to the web application (or mobile application). Or perhaps the content creator sets up the account information later on, after it has been confirmed that there are funds available for the content creator to receive from the copyright owner).

While a web application or mobile application would currently be the most common way for the copyright owner to make copyrighted works available for the uncompensated content creator to use, there are other ways which would work too. The copyrighted works could be delivered through messaging (email, texting, Skype, and other apps which support file sharing), online file transfer services, cloud storage services, peer to peer (including torrenting) or even transferred manually on portable computer drives such as USB drives. Any method which can successfully make the copyrighted works available to the content creator will function for this invention.

### Step 3A:

Uncompensated content creator incorporates traceable copyrighted work into his or her content and then shares content on platform. For example, an uncompensated content creator uses copyrighted music he or she downloaded from a copyright owner's website as background music for a video, and then shares the resulting video on a platform. Another example would be when an uncompensated content creator who makes podcasts combines images or video he or she downloaded from a copyright owner's web or mobile application to the content creator's podcast, and then the content creator shares this combination as a video to a platform. These combinations of video and audio are made using a digital video editor (a popular one available from Apple on Mac devices is called iMovie). There are four kinds of files presently used in digital video editing: files which contain audio data only (such as MP3 or wav files), files which contain video only (such as animated GIF files), files which contain still images (such as JPG and PNG), and files which contain both audio data and video (image) data (such as MP4 and AVI). Digital video editors can be used to combine these various files and save these combinations as a new video file which can be uploaded to a platform such as YouTube or Instagram.

Example: A popular country duo released an “a cappella” version (vocals only, with no instrumentation) of one of their hit songs under the Warner Brothers Nashville record label. A YouTube uncompensated content creator (who is also a musician) downloaded the a cappella version and added his own instrumentation to the a cappella version, using music production software, thereby creating a “remix” of the song. The uncompensated content creator contacted (by phone) the Warner Brothers Nashville Record label to see if it was okay to post the remix on YouTube. The Warner Brothers Nashville representative told the uncompensated content creator to go ahead and post the remix. The uncompensated content creator (after using a video editor to add some photographic images to accompany the remix) then uploaded the remix video onto YouTube. Within a few days, the YouTube Content ID system had recognized the copyrighted a capella version which had been incorporated into the remix, and in the video description which appears under the video, the words “Licensed to YouTube by WMG (on behalf of Warner Nashville); . . . ” were added by YouTube. Advertisements began playing before the remix video would begin when someone attempted to view the remix video. To this day ads run before the remix video plays. As a YouTube content creator, the musician does not qualify for monetization because he does not have 1000 subscribers and his channel has never qualified for monetization. And yet the video is monetized because the copyright owner receives money, that is, a share of the ad revenue from performance of the copyrighted work. The present invention is to share this money with the uncompensated content creator.

It should be noted that some platforms allow video editing to be done within the platform. For instance, YouTube's video editor allows content creators to shorten their video and add visual filters such as changing a color video to black and white. These content editing features on platforms do not affect the method of this invention, as described so far. However, if one of the platform features allows the uncompensated content creator to access the copyright owner's copyrighted work through the platform, and as a result of this access, the copyrighted work is incorporated into the uncompensated content creator's content, then Step 3B should be used instead of Step 3A.

### Step 3B:

Uncompensated content creator gains access to copyright owner's copyrighted work through platform and, as a result of this access, uncompensated content creator incorporates copyright owner's copyrighted work into uncompensated content creator's content. Uncompensated content creator then shares content which contains copyrighted work on platform. As mentioned in Step 3A, media sharing platforms have allowed for content creators to create more of their content within the platform itself. Like YouTube, Instagram allows a content creator to upload a video and then edit the video after it has been uploaded, using a digital editor which is within the Instagram platform. He or she may edit the length of the video, or change the visual characteristics of the video using filters. In addition to these video editing capabilities, Instagram also provides the content creator access to a library of music which he or she can browse and then select from to add music to his or her video. If the copyright owner's copyrighted music, which the uncompensated content creator incorporates into his or her content, is accessed through Instagram, then Step 3B is used instead of Step 3A. In this case, Step 1 (digital fingerprinting or other method of making the copyrighted work traceable) would not have been necessary because the content creator's use of the copyrighted work would be easily identifiable by the platform since the entire action was done from within the platform. And the portion of Step 2 in which the copyrighted work is made available to the content creator by the copyright owner would not be necessary because it is made available through the platform (though not necessary, it still may be useful for the content creator to receive the copyrighted work from the copyright owner because this transfer is accompanied by the terms of use agreement which may still be necessary).

As described in the above Instagram example, Step 3B is used when the platform makes the copyrighted work available to a content creator (such as through a library of music). When Step 3B is used, Step 4 can be skipped.

It should be noted with regard to Steps 3A and 3B, that outside the scope of this invention, the general act of adding background music to a video would not transform that video from one which is unable to be monetized into one which is able to be monetized. However, as a preferable component of this method, the act of incorporating copyrighted work into the uncompensated content creator's content does indeed transform the uncompensated content creator's content from content which cannot be monetized into content which can be monetized (in the case of YouTube, a portion of the ad revenue goes to the copyright owner).

### Step 4:

The traceable copyrighted work which has been combined with the uncompensated content creator's content is identified by a digital fingerprinting system (or other method which can detect and identify the copyrighted work) and the copyright owner is notified that his, her, or its copyrighted work has been shared on the platform. Currently, on YouTube, when Content ID identifies copyrighted work that has been uploaded onto YouTube, the copyright owner is notified and given two choices: To block the content creator's post from appearing on YouTube, or to monetize the post by having YouTube place advertisements before or during the video, and sending a portion of the ad revenue to the copyright owner. (HUGHES, J., “Europe is right. Social media titans should pay up”, Los Angeles Times, Friday, Apr. 19, 2019, Opinion p. All, incorporated herein by reference). Most copyright owners choose to monetize the post and that is the action which would take place in this method.

It should be noted at this point in the method that the preferable components which make up the invention have been established:
a. traceable copyrighted work
b. traceable copyrighted work has been made available to the uncompensated content creator (usually through a web or mobile application).
c. an agreement that the copyright owner will pay the uncompensated content creator a portion of any revenue which the copyright owner receives from performance of the content on the platform.
d. account information given to the copyright owner by the uncompensated content creator so that a portion of the revenue (which has been received from the platform) can be given to the uncompensated content creator.

Thus, the uncompensated content creator has combined the traceable copyrighted material with his or her content (which was unable to be monetized before combining content with the copyrighted work) and received monetization.

By implementing these four components, a special kind of content has been built which has the ability to generate income for a content creator who is otherwise unable to monetize his or her content, because he or she has been excluded from a platform's monetization program(s).

Step 5 and Step 6 describe the final steps in converting the content creator from an uncompensated content creator to compensated. These final steps are the result of the special kind of content having been built and therefore demonstrate the ability of this invention to perform as intended.

### Step 5:

The copyright owner receives revenue from the platform. Currently, if the copyright owner whose copyrighted work has been discovered (by the Content ID system) within posted content chooses to monetize the posted content, YouTube pays the copyright owner a percentage of the ad revenue Youtube makes from ads which run before and during that posted content. For this method, this revenue information will be entered into the web application or mobile application which was utilized in Step 2.

As is often the case in Step 3B, some platforms, such as Instagram, are currently less transparent with regard to disclosing exactly which posts used the copyrighted work on the platform. Such platforms may just make a lump sum payment to the copyright owner for the total amount of ad revenue generated from multiple posts using the copyrighted work. If the copyrighted music used was part of a library made accessible to content creators within the platform, the amount of revenue to be paid to the copyright owners would be based on whatever compensation terms were agreed upon in the previous licensing agreement made between the platform and the copyright owners (usually through a record company, publisher, or distributor who either are the copyright owners or are acting on behalf of the copyright owners). However the revenue is received from the platform (with or without a breakdown of which posts generated the revenue), this revenue information will be submitted into the web application or mobile application utilized in Step 2 in this method.

### Step 6:

Once revenue has been paid from the platform to the copyright owner, the copyright owner gives a portion of that revenue which the copyright owner received to the uncompensated content creator, as was previously agreed in the terms of use in Step 2. This payment will be executed using the same web or mobile application that is utilized in Step 2. In the case of Youtube, this amount would be a portion of the copyright owner's actual income which was generated by the content creator's post. In the case of Instagram where the actual revenue created by each individual content creator may not be disclosed by the platform, this amount would be a portion of the total income which was received from all of the posts which contained the copyrighted work. In this case, the portion of revenue paid to the individual content creator may not reflect the amount of revenue which was generated from that individual content creator's posted content. While the current way YouTube monetizes is preferable, this method is successful in allowing uncompensated content creators to monetize their posted content (thereby converting them to compensated content creators) in either situation.

Since the content creator was able to collect a portion of the platform's revenue, despite being excluded from the platform's monetization program(s), the special kind of content which has been built through this method has functioned as intended.
A final note is that the type of revenue which has been paid to the copyright owner by YouTube (and then by the copyright owner to the content creator) has been revenue from advertisements which play before or during videos which are being viewed. It is possible that in other situations (besides the current YouTube example), this revenue could come from other sources.

For instance, a platform such as YouTube could create a subscription program which allowed subscribers to watch videos without being subjected to advertisements. In this case, Youtube may give a portion of the revenue Youtube collects from program subscribers to the copyright owner, and then the copyright owner would give a portion of this subscription revenue to the content creator. For this invention, the revenue which is being paid from the platform to the copyright owner (and then from the copyright owner to the content creator) could be from a source other than advertising revenue.

### INDUSTRIAL APPLICABILITY

The present invention is applicable whenever it is desired to provide compensation to uncompensated content creators who share copyrighted works on platforms.

What is claimed is:

1. A process for copyright owners to use identifiable copyrighted works, comprising:
making available said identifiable copyrighted works to be incorporated into online content by online content creators who have been excluded from monetization of their content by platforms for not meeting said platforms' channel subscriber or viewing hours monetization requirements;
receiving compensation from said platforms for use of said copyrighted works when said content with incorporated said identifiable copyrighted works has been shared on said platform; and
paying said content creators a portion of said compensation.

2. A process for content creators, who have been excluded from monetization of their content by platforms for not meeting said platforms' monetization requirements, to use identifiable copyrighted works, comprising:
agreeing with owners of said identifiable copyrighted works to share compensation from use of said identifiable copyrighted works on platforms;
selecting said identifiable copyrighted works offered by said owners of said identifiable copyrighted works;
incorporating said identifiable copyrighted works into said content;
sharing said content on said platforms, whereby compensation to said owners of said identifiable copyrighted works is generated; and
receiving a portion of said compensation.

3. A process for copyright owners to encourage broader usage of traceable copyrighted works on platforms, and to increase revenue from said traceable copyrighted works, comprising:
making available said traceable copyrighted works, to be incorporated into online content by online content creators who have been excluded from monetization of their content by said platforms for not meeting said platforms' monetization requirements;
receiving compensation from said platforms for use of said traceable copyrighted works when said content with incorporated said traceable copyrighted works has been shared on said platform; and
paying said content creators a portion of said compensation.

4. A process for platforms that own identifiable copyrighted works to encourage broader usage of said identifiable copyrighted works on said platforms, and to increase revenue from said identifiable copyrighted works, comprising:
making available said identifiable copyrighted works, to be incorporated into online content by online content creators who have been excluded from monetization by said platforms for not meeting said platforms' monetization requirements;
paying compensation to said online content creators for use of said copyrighted works when said content with incorporated said identifiable copyrighted works has been shared on said platform.

5. A process for copyright owners of identifiable copyrighted works to encourage broader usage of said copyrighted works on platforms, and to increase revenue from said identifiable copyrighted works, comprising:
making available to online content creators who have been excluded from monetization by said platforms for not meeting said platforms' channel subscriber or viewing hours monetization requirements, identifiable copyrighted works to be incorporated into content to be shared on said platforms, whereby when said content creators share, on said platforms, content incorporating said copyrighted works, said copyright owners receive compensation for use of said copyrighted works; and
paying said content creators a portion of said compensation.

6. A process for a platform to compensate online content creators, who have been excluded from monetization by said platform for not meeting said platform's monetization requirements, when said content creators share on said platform, content incorporating identifiable copyrighted works owned by a copyright owner, comprising:
making available to said content creators said identifiable copyrighted works for selection of at least one of said copyrighted works to be incorporated into said content; and
paying said copyright owner a share of compensation for use of said identifiable copyrighted work when said content has been shared on said platform; and
paying said content creators a share of said compensation.

7. A process for a copyright owner to encourage broader usage of identifiable copyrighted works on platforms, and to increase revenue from said identifiable copyrighted works, comprising:
making available said identifiable copyrighted works, to be incorporated into online content by online content creators who have been excluded from monetization of their content by said platforms for not meeting said platforms' monetization requirements;
receiving compensation from said platforms for use of said identifiable copyrighted works when said content with incorporated said identifiable copyrighted works has been shared on said platform; and
paying said content creators a portion of said compensation.

8. A process according to claim 7, wherein said content creators have been excluded for not meeting said platforms' channel subscriber or viewing hours monetization requirements.

9. The process of using identifiable copyrighted works incorporated into content by content creators who have been excluded from monetization for failing to meet platforms' monetization requirements, comprising:
triggering payment of compensation to owners of said identifiable copyrighted works when said content is shared on said platforms,
wherein said copyright owners pay portions of said compensation to said content creators.

10. A process for a copyright owner to use identifiable copyrighted works, comprising:
making available said identifiable copyrighted works to content creators to be incorporated into content to be shared on platforms; and
sharing with said content creators, revenue paid to said copyright owner by said platforms.

11. A process according to claim 10, wherein said making available step is performed by including a key word identifying said copyright owner in said copyrighted works' titles.
